(19) United States
(12) Patent Application Publication
(10) Pub. No.: US 2024/0079587 A1
(43) Pub. Date: Mar. 7, 2024

(54) COMPOSITE CATHODES FOR LI-ION BATTERIES

(71) Applicant: Rivian IP Holdings, LLC, Plymouth, MI (US)

(72) Inventors: Soo KIM, Fremont, CA (US); Sun Ung KIM, Pleasanton, CA (US); Sookyung JEONG, San Jose, CA (US); Majid TALEBIESFANDARANI, Emeryville, CA (US); Tae Kyoung KIM, Albany, CA (US); Ki Tae PARK, Santa Clara, CA (US)

(21) Appl. No.: 17/929,594

(22) Filed: Sep. 2, 2022

(51) Int. Cl. H01M 4/58; H01M 4/36; H01M 4/485; H01M 4/505; H01M 4/525; H01M 10/0525

(52) U.S. Cl. CPC H01M 4/5825; H01M 4/364; H01M 4/366; H01M 4/485; H01M 4/505; H01M 4/525; H01M 10/0525; H01M 2004/021

(57) ABSTRACT

Provided are electrodes for a lithium-ion batteries comprising a lithium metal phosphate material, an over-lithiated-oxide material, and a high nickel manganese cobalt oxide material. In some embodiments, an electrode includes a blend of the lithium metal phosphate, the over-lithiated-oxide, and the high nickel manganese cobalt oxide materials. Also provided are rechargeable lithium-ion batteries and electric vehicle systems with an electrode comprising a lithium metal phosphate material, an over-lithiated-oxide material, and a high nickel manganese cobalt oxide material.

### INTRODUCTION

The present disclosure generally relates to electrodes, and more particularly, to composite electrodes for lithium-ion batteries.

### SUMMARY

Provided are composite electrodes comprising a system of three different active materials. Also provided herein are rechargeable lithium-ion batteries having an electrode comprising a system of three different active materials, and electric vehicle systems comprising an electrode having a system of three different active materials. Specifically, the electrodes described herein can include a system of a lithium metal phosphate material, an over-lithiated-oxide (OLO) material, and a high nickel manganese cobalt oxide (NMC) material. In some embodiments, the electrode, rechargeable lithium-ion battery, and/or electric vehicle system comprise a system or blend of an LMFP material, an OLO material, and an NMC material. In some embodiments, the three active materials are used to fabricate a cathode for a rechargeable lithium-ion battery.

Electrodes (and rechargeable lithium-ion batteries comprising electrodes) formed from a blend or a system of three different active material (i.e., an LMFP material, an OLO material, and an NMC material) can achieve specific target properties. Conversely, an electrode or a rechargeable lithium-ion battery comprising only an LMFP material may have low energy density, low tap density, and/or low packing density, when compared to NMC and/or OLO. An electrode or a rechargeable lithium-ion battery comprising only an OLO material may exhibit irreversible capacity in the Pt cycle activation (i.e., initial columbic efficiency), oxygen gas evolution during Pt cycle activation, and/or fading of the voltage/capacity over extended cycling. Further, an electrode or a rechargeable lithium-ion battery comprising only an NMC material may have safety concerns, a low thermal runaway temperature, and/or cycling decreases, if charged to or near 100% state of charge (SOC). However, an electrode or a rechargeable lithium-ion battery formed using a blend or system of an LMFP material, an OLO material, and an NMC material can have increased capacity (as compared to that comprising only an LMFP material), increased thermal stability (as compared to that comprising only an NMC material), and/or a reduced irreversibility (as compared to that comprising only an OLO material).

In some embodiments, the three different active materials may be used together at a specified ratio to achieve the desired performance properties. For example, an LMFP material, an OLO material, and an NMC material may be used in an electrode at a ratio having a higher proportion of the LMFP material. For example, the ratio may include greater than or equal to 60% LMFP material, and less than or equal to 40% combined of the OLO material and the NMC material. Such embodiments may achieve electrodes and rechargeable lithium-ion batteries having increased thermal safety, reduced cost, increased capacity, and reversibility.

In some embodiments, an LMFP material, an OLO material, and an NMC material may be used in an electrode at a ratio having a higher proportion of the NMC material and the OLO material. For example, the ratio may include greater than or equal to 80% NMC/OLO combination, and less than or equal to 20% LMFP material. Such embodiments may achieve electrodes and rechargeable lithium-ion batteries having increased safety, high capacity, high voltage, high packing density, and improved adhesion.

The different active materials may also be used to form different deposition layers/configurations, depending on the application. For example, a blend of an LMFP material, an OLO material, and an NMC material may be used to form a single deposition layer on a current collector. In some embodiments, a first layer of only an NMC material may be deposited onto a current collector, and a second layer comprising a blend of an LMFP material, an OLO material, and an NMC material may be deposited onto the first NMC layer. In some embodiments, a first layer that does not comprise an LMFP material can help improve adhesion to the current collector. Additional embodiments of deposition configurations are described further below.

In some embodiments, provided is an electrode for a lithium-ion battery comprising: a lithium metal phosphate material; an over-lithiated-oxide material; and a high nickel manganese cobalt oxide material.

In some embodiments of the electrode, the lithium metal phosphate material comprises LiMnₓFe₁₋ₓPO₄, where 0.5≤x≤0.9.

In some embodiments of the electrode, the over-lithiated-oxide material comprises Li_{1+y}M_{1-y}O₂, where 0≤y≤0.4.

In some embodiments of the electrode, the high nickel manganese cobalt oxide material comprises LiNi_{0.8+z}(Co,Mn,Al)_{0.2-z}O₂, where 0≤z≤0.2.

In some embodiments of the electrode, one or more of: the lithium metal phosphate material has a D50 of 0.7-11.0 μm, the over-lithiated-oxide material has a D50 of 3-14 μm, or the high nickel manganese cobalt oxide material has a D50 of 3-15 μm.

In some embodiments of the electrode, one or more of: the lithium metal phosphate material has a tap density of 0.8-1.3 g/cm³, the over-lithiated-oxide material has a tapped density of 0.8-1.4 g/cm³, or the high nickel manganese cobalt oxide material has a tapped density of 1.5-3.1 g/cm³.

In some embodiments of the electrode, one or more of: the lithium metal phosphate material has a pellet density of 2-2.3 g/cm³, the over-lithiated-oxide material has a pellet density of 2.7-3.2 g/cm³, or the high nickel manganese cobalt oxide material has a pellet density of 3.3-3.8 g/cm³.

In some embodiments of the electrode, one or more of: the lithium metal phosphate material has a specific surface area of 10-35 m²/g, the over-lithiated-oxide material has a specific surface area of 1-6 m²/g, or the high nickel manganese cobalt oxide material has a specific surface area of 0.2-1 m²/g.

In some embodiments of the electrode, the lithium metal phosphate material has a carbon content of 1.0-3.5 wt. %.

In some embodiments of the electrode, the electrode comprises greater than or equal to 60 wt. % lithium metal phosphate material.

In some embodiments of the electrode, the electrode comprises less than or equal to 40 wt. % over-lithiated-oxide material and high nickel manganese cobalt oxide material combined.

In some embodiments of the electrode, the electrode comprises a single deposited layer of a blend of the lithium metal phosphate material, the over-lithiated-oxide material, and the high nickel manganese cobalt oxide material.

In some embodiments of the electrode, the electrode comprises a first deposited layer comprising only one of the high nickel manganese cobalt oxide material or the over-lithiated-oxide material.

In some embodiments of the electrode, the electrode comprises a second deposited layer overlying the first deposited layer comprising a blended mixture of two or more of the lithium metal phosphate material, the over-lithiated-oxide material, and the high nickel manganese cobalt oxide material.

In some embodiments of the electrode, the electrode comprises a first deposited layer comprising only the high nickel manganese cobalt oxide material and the over-lithiated-oxide material.

In some embodiments of the electrode, the first deposited layer comprises a nanocomposite of the high nickel manganese cobalt oxide material and the over-lithiated-oxide material, and the electrode comprises a second deposited layer comprising only the lithium metal phosphate material overlying the first deposited layer.

In some embodiments of the electrode, the first deposited layer comprises a homogenous mixture of the high nickel manganese cobalt oxide material and the over-lithiated-oxide material, and the electrode comprises a second deposited layer comprising only the lithium metal phosphate material overlying the first deposited layer.

In some embodiments, a rechargeable lithium-ion battery is provided, the rechargeable lithium-ion battery comprising: an electrode comprising: a lithium metal phosphate material; an over-lithiated-oxide material; and a high nickel manganese cobalt oxide material.

In some embodiments of the battery, the battery has a specific capacity of 175-240 mAh/g and a nominal voltage of 3.7-4.0 V vs. graphite.

In some embodiments, an electric vehicle system comprising a rechargeable lithium-ion battery is provided, the rechargeable lithium-ion battery comprising: an electrode comprising: a lithium metal phosphate material; an over-lithiated-oxide material; and a high nickel manganese cobalt oxide material.

The embodiments disclosed above are only examples, and the scope of this disclosure is not limited to them. Particular embodiments may include all, some, or none of the components, elements, features, functions, operations, or steps of the embodiments disclosed above. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE FIGURES

FIG. 1A shows thermal stability for various individual active materials, according to some embodiments;

FIG. 1B shows thermal stability for various blended active materials, according to some embodiments;

FIG. 2 shows a charge and discharge voltage versus capacity curve, according to some embodiments;

FIG. 3A shows an electrode configuration, according to some embodiments;

FIG. 3B shows an electrode configuration, according to some embodiments;

FIG. 3C shows an electrode configuration, according to some embodiments;

FIG. 3D shows an electrode configuration, according to some embodiments;

FIG. 3E shows an electrode configuration, according to some embodiments;

FIG. 4 shows an illustrative representation of coated active material particles, according to some embodiments;

FIG. 5 illustrates a flow chart for a typical battery cell manufacturing process, according to some embodiments;

FIG. 6 depicts an illustrative example of a cross sectional view of a cylindrical battery cell, according to some embodiments;

FIG. 7 depicts an illustrative example of a cross sectional view of a prismatic battery cell, according to some embodiments;

FIG. 8 depicts an illustrative example of a cross sectional view of a pouch battery cell, according to some embodiments;

FIG. 9 illustrates cylindrical battery cells being inserted into a frame to form battery module and pack, according to some embodiments;

FIG. 10 illustrates prismatic battery cells being inserted into a frame to form battery module and pack, according to some embodiments;

FIG. 11 illustrates pouch battery cells being inserted into a frame to form battery module and pack, according to some embodiments; and

FIG. 12 illustrates an example of a cross sectional view of an electric vehicle that includes at least one battery pack, according to some embodiments.

### DETAILED DESCRIPTION

Provided herein are electrodes comprising a system or blend of three different active materials, lithium-ion batteries having electrodes comprising a system or blend of three different active materials, and electric vehicle systems comprising a lithium-ion battery having a system or blend of three different active materials. Specifically, the three different active materials include an LMFP material, an OLO material, and an NMC material.

Most electric vehicles rely on rechargeable lithium-ion batteries as the primary source of power. The cathode of the rechargeable lithium-ion battery, and more specifically the electrochemistry of the rechargeable lithium-ion battery, can affect the performance of the battery (e.g., energy density, cycle life). For example, one commonly-used cathode material for rechargeable lithium-ion batteries is lithium metal phosphate material (LiMPO₄), where M can be iron (Fe) or manganese (Mn), or a mixture of both Fe and Mn. In some embodiments, the lithium metal phosphate material used herein may comprise LiMnₓFe₁₋ₓPO₄, wherein x is 0.5-0.8. In some embodiments, x is less than or equal to 0.8, 0.75, 0.7, 0.65, 0.6, or 0.55. In some embodiments, x is greater than or equal to 0.5, 0.55, 0.6, 0.65, 0.7, or 0.75.

Another cathode material that can be used for rechargeable lithium-ion batteries is OLO. OLO materials are defined as materials comprising more than one molar equivalent of lithium relative to the amount of transition metals in a crystal structure. OLOs also generally require charging above 4.4 V to access the extra lithium, where Li₂MnO₃-like region in OLO needs to be activated by releasing oxygen gas. In some embodiments, OLO materials may be defined as Li_{1+y} NMC materials (nickel manganese cobalt). In some embodiments, nickel, manganese, or cobalt may be doped or substituted by aluminum that help with redox chemistry, surface stabilization, suppressing gas evolution, etc. In some embodiments, the OLO material may comprise Li_{1+y}M_{1-y}O₂, wherein y is typically less than 0.3.

A further cathode material that can be used for rechargeable lithium-ion batteries are NMC materials. NMC materials are defined as ternary cathode materials comprising nickel, manganese, and cobalt and generally comprise 33 wt. % or greater nickel, and often 80 wt. % or greater nickel. Specifically, high nickel manganese cobalt oxide materials can be defined as comprising 80 wt. % or more nickel. Different molar ratio between nickel, manganese, and cobalt have been synthesized: e.g., NMC111, NMC523, NMC622, NMC811, and so on. Aluminum can be substituted in the transition metal site for the stabilization purpose. In some embodiments, the high nickel, NMC material comprises of at least 80% Ni, e.g., LiNi_{0.8+z}(Co,Mn,Al)_{0.2-z}O₂, wherein z is 0-0.2. In some embodiments, z may be less than or equal to 0.2, 0.19, 0.18, 0.17, 0.16, 0.15, 0.14, 0.13, 0.12, 0.11, 0.1, 0.09, 0.08, 0.07, 0.06, 0.05, 0.04, 0.03, 0.02, or 0.01. In some embodiments, z may be greater than or equal to 0, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, or 0.19. In some embodiments, when the nickel content becomes more than 88%, the NMC may be referred to as NCMA (where Al is a stabilizer).

As described herein, the three active materials can be combined at specific ratios to achieve an electrode or rechargeable lithium-ion battery comprising the electrode having improved performance properties as compared to electrodes (or rechargeable lithium-ion batteries comprising an electrode) comprising only one of the three active materials or even a blend of two of the three active materials. For example, an electrode (or a rechargeable lithium-ion batteries comprising an electrode) comprising a system or blend of an LMFP material, an OLO material, and an NMC material can have performance properties superior to that of an electrode or a rechargeable lithium-ion battery comprising only one of an LMFP material, an OLO material, or an NMC material, or a blend of any two of an LMFP material, an OLO material, or an NMC material.

### Active Materials

As described herein, a system or blend of an LFMP material, and OLO material, and an NMC material is used in electrodes (e.g., cathodes) for rechargeable lithium-ion batteries. The specific properties of each of the individual materials influences the properties of a blend or system of the three materials combined, and the performance properties of an electrode and an electric vehicle system comprising the LMFP/OLO/NMC blend or system.

Below is a table comprising suitable ranges of properties of each of the individual active materials.

| Materials | LMFP | OLO | NMC or NMC(A) |
|---|---|---|---|
| Particle size diameter | 0.1-2.5 | 1-7 | 1.8-6.6 |
| D10 (μm) | | | |
| Particle size diameter | 0.7-11.0 | 3-14 | 3.0-15 |
| D50 (μm) | | | |
| Particle size diameter | 3.7-29.5 | 10-25 | 5.2-22.6 |
| D90 (μm) | | | |
| Tap Density (g/cm³) | 0.8-1.3 | 0.8-1.4 | 1.5-3.1 |
| Pellet Density | 2.0-2.3 | 2.7-3.2 | 3.3-3.8 |
| (g/cm³) | | | |
| Specific Surface Area | 10-35 | 1-6 | 0.2-1.0 |
| (m²/g) | | | |
| Carbon (wt %) | 1.5-3.5 | N/A | N/A |
| Manganese/ | 60-80 | 50-75 | 0.5-10 |
| (Transition Metal) | | | |
| (mol %) | | | |
| Iron/(Transition | 20-40 | N/A | N/A |
| Metal) (mol %) | | | |
| Nickel/(Transition | N/A | 20-50 | 80-96 |
| Metal) (mol %) | | | |
| 1st Charge @0.1 C | 153-163 | 220-310 | 200-243 |
| (mAh/g) | | | |
| 1st Discharge @0.1 C | 145-158 | 160-270 | 183-219 |
| (mAh/g) | | | |
| Initial Columbic | 94.8-96.9 | 78.0-90.0 | 88.0-94.2 |
| Efficiency (%) | | | |

Particle Size Diameter: As used herein, “D50” refers to the median particle size measured from the particle size analyzer (PSA), or the particle size (diameter) at 50% in a cumulative distribution. Since primary particle tends to aggregate to each other, especially in nanosized powders, the PSA measurement value (e.g., D10, D50, D90, D100) does not always represent the size of single-crystal particle. Further, as used here, “D10” refers to the particle size (diameter) at 10% in a cumulative distribution, and “D90” refers to the particle size (diameter) at 90% in a cumulative distribution.

In some embodiments, the LMFP material used herein may have a particle size (D10) of 0.1-2.5 μm. In some embodiments, the LMFP material used herein may have a particle size (D10) of less than or equal to 2.5, 2, 1.5, 1, or 0.5 μm. In some embodiments, the LMFP material used herein may have a particle size (D10) of greater than 0.1, 0.5, 1, 1.5, or 2 μm. In some embodiments, the LMFP material used herein may have a particle size (D50) of 0.7-11 μm. In some embodiments, the LMFP material used herein may have a particle size (D50) of less than or equal to 11, 7.5, 5, 2.5, or 1 μm. In some embodiments, the LMFP material used herein may have a particle size (D50) of greater than or equal to 0.7, 1, 2.5, 5, 7.5, or 10 μm. In some embodiments, the LMFP material used herein may have a particle size (D90) of 3.7-29.5 μm. In some embodiments, the LMFP material used herein may have a particle size (D90) of less than or equal to 29.5, 20, or 10 μm. In some embodiments, the LMFP material used herein may have a particle size (D90) of greater than or equal to 3.7, 10, or 20 μm. Depending on the measurement equipment, procedure, dispersant, solvent, aggregation, the particle distribution may be affected by about ±2 μm.

In some embodiments, the OLO material used herein may have a particle size (D10) of 1-7 μm. In some embodiments, the OLO material used herein may have a particle size (D 10) of less than or equal to 7, 5, or 3 OLO material used herein may have a particle size (D10) of greater than or equal to 1, 3, or 5. In some embodiments, the OLO material used herein may have a particle size (D50) of 3-14 μm. In some embodiments, the OLO material used herein may have a particle size (D50) of less than or equal to 14, 12, 10, 8, 6, or 4 μm. In some embodiments, the OLO material used herein may have a particle size (D50) of greater than or equal to 3, 4, 6, 8, 10, or 12 μm. In some embodiments, the OLO material used herein may have a particle size (D90) of 10-25 μm. In some embodiments, the OLO material used herein may have a particle size (D90) of less than or equal to 25, 20, or 15 μm. In some embodiments, the OLO material used herein may have a particle size (D90) of greater than or equal to 10, 15, or 20 μm.

In some embodiments, the NMC material used herein may have a particle size (D10) of 1.8-6.6 μm. In some embodiments, the NMC material used herein may have a particle size (D10) of less than or equal to 6.6, 6, 5, 4, 3, or 2 μm. In some embodiments, the NMC material used herein may have a particle size (D10) greater than or equal to 1.8, 2, 3, 4, 5, or 6 μm. In some embodiments, the NMC material used herein may have a particle size (D50) of 3-15 μm. In some embodiments, the NMC material used herein may have a particle size (D50) of less than or equal to 15, 12, 9, or 6 μm. In some embodiments, the NMC material used herein may have a particle size (D50) of greater than or equal to 3, 6, 9, or 12 μm. In some embodiments, the NMC material used herein may have a particle size (D90) of 5.2-22.6 μm. In some embodiments, the NMC material used herein may have a particle size (D90) of less than or equal to 22.6, 20, 15, or 10 μm. In some embodiments, the NMC material used herein may have a particle size (D90) of greater than or equal to 5.2, 10, 15, or 20 μm.

Tap Density: In some embodiments, the LMFP material may have a tap density of 0.8-1.3 g/cm³. In some embodiments, the LMFP material may have a tap density of less than or equal to 1.3, or 1 g/cm³. In some embodiments, the LMFP material may have a tap density of greater than or equal to 0.8 or 1 g/cm³. In some embodiments, the OLO material may have a tap density of 0.8-1.4 g/cm³. In some embodiments, the OLO material may have a tap density of less than or equal to 0.4, 1.2, or 1 g/cm³. In some embodiments, the OLO material may have a tap density of greater than or equal to 0.8, 1, or 1.2 g/cm³. In some embodiments, the NMC material may have a tap density of 1.5-3.1 g/cm³. In some embodiments, the NMC material may have a tap density of less than or equal to 3.1, 2.5, or 2 g/cm³. In some embodiments, the NMC material may have a tap density of greater than or equal to 1.5, 2, or 2.5 g/cm³.

Pellet Density: In some embodiments, the LMFP material may have a pellet density of 2-2.3 g/cm³. In some embodiments, the LMFP material may have a pellet density of less than or equal to 2.3, 2.2, or 2.1 g/cm³. In some embodiments, the LMFP material may have a pellet density of greater than or equal to 2, 2.1, or 2.2 g/cm³. In some embodiments, the OLO material may have a pellet density of 2.7-3.2 g/cm³. In some embodiments, the OLO material may have a pellet density of less than or equal to 3.2 or 3 g/cm³. In some embodiments, the OLO material may have a pellet density greater than or equal to 2.7 or 3 g/cm³. In some embodiments, the NMC material may have a pellet density of 3.3-3.8 g/cm³. In some embodiments, the NMC material may have a pellet density of less than or equal to 3.8 or 3.5 g/cm³. In some embodiments, the NMC material may have a pellet density of greater than or equal to 3.3 or 3.5 g/cm³.

Specific Surface Area: In some embodiments, the LMFP material may have a specific surface area of 10-35 m²/g. In some embodiments, the LMFP material may have a specific surface area less than or equal to 35, 30, 25, 20, or 15 m²/g. In some embodiments, the LMFP material may have a specific surface area greater than or equal to 10, 15, 20, 25, or 30 m²/g. This is due to low ionic conductivity of LMFP, therefore preparing LMFP as nano-sized particles. As the particle size decreases, the specific surface area increases significantly. In some embodiments, the OLO material may have a specific surface area of 1-6 m²/g. In some embodiments, the OLO material may have a specific surface area less than or equal to 6, 4, or 2 m²/g. In some embodiments, the OLO material may have a specific surface area greater than or equal to 1, 2, or 4 m²/g. In some embodiments, the NMC material may have a specific surface area of 0.2-1 m²/g. In some embodiments, the NMC material may have a specific surface area less than or equal to 1, 0.8, 0.6, or 0.4 m²/g. In some embodiments, the NMC material may have a specific surface area greater than or equal to 0.2, 0.4, 0.6, or 0.8 m²/g.

Carbon content: In some embodiments, the LMFP material may have a carbon content of 1.0-3.5 wt. %. In some embodiments, the LMFP material may have a carbon content less than or equal to 3.5, 3, 2.5, or 2 wt. %. In some embodiments, the LMFP material may have a carbon content greater than or equal to 1.0, 1.5, 2, 2.5, or 3 wt. %. Most of carbon stays as surface coating on the LMFP materials that help with electronic conductivity.

Manganese per transition metals: In some embodiments, the LMFP material may have 50-90 mol % manganese per transition metals. In some embodiments, the LMFP material may have less than or equal to 90 or 75 mol % manganese per transition metals. In some embodiments, the LMFP material may have greater than or equal to 50 or 75 mol % manganese per transition metals. In some embodiments, the OLO material may have 50-75 mol % manganese per transition metals. In some embodiments, the OLO material may have less than or equal to 75, 70, 65, 60, or 55 mol % manganese per transition metals. In some embodiments, the OLO material may have greater than or equal to 50, 55, 60, 65, or 70 mol % manganese per transition metals. In some embodiments, the high Ni NMC material may have 0.5-10 mol % manganese per transition metals. In some embodiments, the high Ni NMC material may have less than or equal to 10, 7.5, 5, or 2.5 mol % manganese per transition metals. In some embodiments, the high Ni NMC material may have greater than 0.5, 2.5, 5, or 7.5 mol % manganese per transition metals.

Iron per transition metals: In some embodiments, the LMFP material may have 10-50 mol % iron per transition metals. In some embodiments, the LMFP material may have less than or equal to 50 or 30 mol % iron per transition metals. In some embodiments, the LMFP material may have greater than or equal to 10 or 30 mol % iron per transition metals.

Nickel per transition metals: In some embodiments, the OLO material may have 20-50 mol % nickel per transition metals. In some embodiments, the OLO material may have less than or equal to 50, 40, or 30 mol % nickel per transition metals. In some embodiments, the OLO material may have greater than or equal to 20, 30, or 40 mol % nickel per transition metals. In some embodiments, the NMC material may have 80-96 mol % nickel per transition metals. In some embodiments, the NMC material may have less than or equal to 96, 90, 85 mol % nickel per transition metals. In some embodiments, the NMC material may have greater than or equal to 80, 85, or 90 mol % nickel per transition metals.

First Charge @ 0.1C rate: In some embodiments, an electrode comprising the LMFP material may have a first charge at 0.1C of 153-163 mAh/g. In some embodiments, an electrode comprising the LMFP material may have a first charge at 0.1C less than or equal to 163, 160, or 155 mAh/g. In some embodiments, an electrode comprising the LMFP material may have a first charge at 0.1C greater than or equal to 153, 155, or 160 mAh/g. In some embodiments, an electrode comprising the OLO material may have a first charge at 0.1C of 220-310 mAh/g. In some embodiments, an electrode comprising the OLO material may have a first charge at 0.1C less than or equal to 310, 300, or 250 mAh/g. In some embodiments, an electrode comprising the OLO material may have a first charge at 0.1C greater than or equal to 220, 250, or 300 mAh/g. In some embodiments, an electrode comprising the NMC material may have a first charge at 0.1C of 200-243 mAh/g. In some embodiments, an electrode comprising the NMC material may have a first charge at 0.1C less than or equal to 243 or 225 mAh/g. In some embodiments, an electrode comprising the NMC material may have a first charge at 0.1C greater than or equal to 200 or 225 mAh/g.

First Discharge @ 0.1C rate: In some embodiments, an electrode comprising the LMFP material may have a first discharge at 0.1C of 145-158 mAh/g. In some embodiments, an electrode comprising the LMFP material may have a first discharge at 0.1C less than or equal to 158 or 150 mAh/g. In some embodiments, an electrode comprising the LMFP material may have a first discharge at 0.1C greater than 145 or 150 mAh/g. In some embodiments, an electrode comprising the OLO material may have a first discharge at 0.1C of 160-270 mAh/g. In some embodiments, an electrode comprising the OLO material may have a first discharge at 0.1C less than or equal to 270, 250, or 200 mAh/g. In some embodiments, an electrode comprising the OLO material may have a first discharge at 0.1C greater than or equal to 160, 200, or 250 mAh/g. In some embodiments, an electrode comprising NMC material may have a first discharge at 0.1C of 183-219 mAh/g. In some embodiments, an electrode comprising NMC material may have a first discharge at 0.1C less than or equal to 219 or 200 mAh/g. In some embodiments, an electrode comprising NMC material may have a first discharge at 0.1C greater than or equal to 183 or 200 mAh/g.

Initial columbic efficiency (ICE): ICE is defined as first discharge capacity divided by first charge capacity. In some embodiments, an electrode comprising the LMFP material may have an ICE from 94.8% to 96.9%. In some embodiments, an electrode comprising the OLO material may have an ICE from 78.0% to 90.0%. In some embodiments, an electrode comprising the NMC material may have an ICE from 88.0% to 94.2%. The ICE in the full cell configuration is likely less than 100%, because graphite consumes Li⁺ ions from the cathode to form the solid-electrolyte interface (SEI) layer. The N/P ratio (amount of negative to positive electrode) may be controlled, in order to tune the ICE value, when a battery cell is being designed based on the electrochemistry and target application.

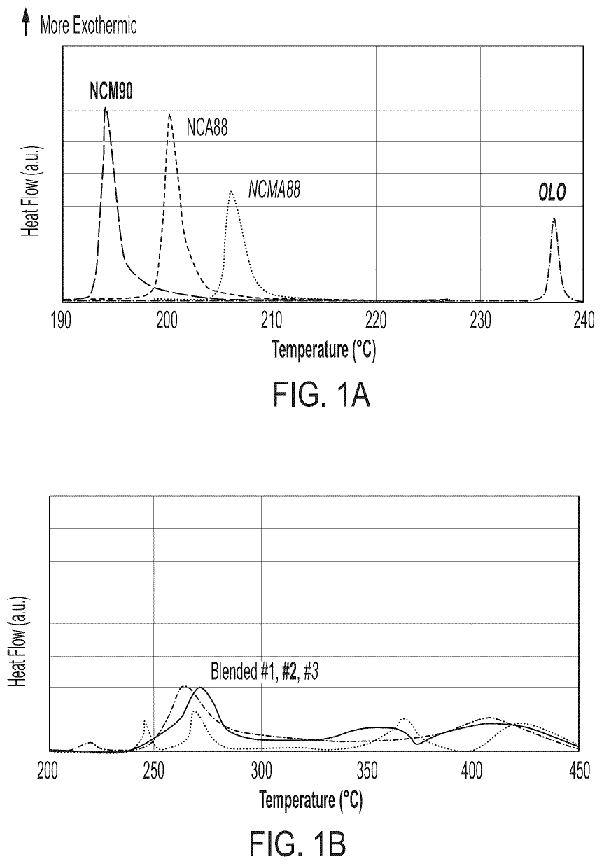

FIG. 1A shows the thermal stability of several individual active materials. Specifically, FIG. 1A shows the thermal stability of three different NMC materials (i.e., NCM90, NCA88, NCMA88) commonly used in electrodes for rechargeable lithium-ion batteries as well as an OLO material (e.g., Li_{1.15}(Mn_{0.6}Ni_{0.3}Co_{0.1})_{0.85}O₂). As shown, the OLO material has significantly better thermal stability than any of the NMC materials, showing thermal runaway onset temperature is significantly higher, as well as total heat flow is less than high Ni NMC materials. Increased thermal stability can improve the thermal safety of a rechargeable lithium-ion battery fabricated using the thermally stable active material. Further, the thermal stability increases as the manganese content of the material increases.

FIG. 1B shows the thermal stability for various active material blends, according to some embodiments described herein. By blending cathode materials, it is possible to increase the thermal on-set temperature, when compared to using high Ni NMC as the sole cathode material. Increased OLO contents shifts the onset temperature around 260° C., from 190-210° C. ranges. Above ˜350° C. region corresponds to thermal decomposition of LMFP, which are superior in terms of thermal stability when compared with OLO and NMCs. As shown, the thermal stability of three separate blends of an LMFP material, an OLO material, and an NMC material are shown. As compared to the thermal stability of the individual materials provided in FIG. 1A, these blends each demonstrate a lower generation of exothermic heat as the temperature increases. Blended #3 sample with a ratio between LMFP, NMC, OLO ratio focusing on high energy application (e.g., LMFP:NMC:OLO=20:40:40) has a highest layered cathode content (i.e., NMC/OLO) than Blended samples #1 and #2, where thermal runaway starts slightly lower temperature at ˜220° C. Blended #1 sample may have a reduced NMC amount than blended #2 (e.g., LMFP:NMC:OLO=60:20:20). Blended sample #2 focusing on the thermal safety may have the least amount of NMC but maximizing the OLO and LMFP contents (e.g., LMFP:NMC:OLO=70:5:25).

### Systems or Blends of Active Materials

As mentioned above, the specific combination or blending ratio of the three different active materials can help achieve target performance properties. The particular target performance properties (and thus, the ratio of the three materials) can depend on the specific application of the electrode/battery.

In some embodiments, the three active materials may be combined to achieve an LMFP-rich region. In such embodiments, the total amount of the LMFP material may be greater than or equal to 60 wt. %, and the total amount of the OLO material and the NMC materials combined may be less than or equal to 40 wt. %. In some embodiments, the total amount of the LMFP material may be 60-98 wt. %. In some embodiments, the total amount of the LMFP material may be less than or equal to 98, 95, 90, 85, 80, 75, 70, or 65 wt. %. In some embodiments, the total amount of the LMFP material may be greater than or equal to 60, 65, 70, 75, 80, 85, 90, or 95 wt. %. In some embodiments, the total amount of the OLO material and the NMC materials combined may be 2-40 wt. %. In some embodiments, the total amount of the OLO material and the NMC materials combined may be less than or equal to 40, 35, 30, 25, 20, 15, 10, or 5 wt. %. In some embodiments, the total amount of the OLO material and the NMC materials combined may be greater than or equal to 2, 5, 10, 15, 20, 25, 30, or 35 wt. %. In some embodiments, the OLO material and the NMC material may be combined in equal amounts. In some embodiments, the OLO material and the NMC material may be combined in unequal amounts.

In some embodiments, the three active materials may be combined to achieve an OLO/NMC material-rich region. In such embodiments, the total amount of the OLO and NMC materials combined may be greater than or equal to 80 wt. %, and the total amount of the LMFP material may be less than or equal to 20 wt. %. In some embodiments, the total amount of the OLO and NMC materials combined may be 80-98 wt. %. In some embodiments, the total amount of the OLO and NMC materials combined may be less than or equal to 98, 95, 90, or 85 wt. %. In some embodiments, the total amount of the OLO and NMC materials combined may be greater than or equal to 80, 85, 90, or 95 wt. %. In some embodiments, the total amount of the LMFP material may be 2-20 wt. %. In some embodiments, the total amount of the LMFP material may be less than or equal to 20, 15, 10, or 5 wt. %. In some embodiments, the total amount of the LMFP material may be greater than or equal to 2, 5, 10, or 15 wt. %. In some embodiments, the OLO material and the NMC material may be combined in equal amounts. In some embodiments, the OLO material and the NMC material may be combined in unequal amounts.

Below is a chart providing some example LMFP/OLO/NMC ratios and associated performance properties and characteristics.

| | Specific | Nominal | Energy | |
|---|---|---|---|---|
| | Capacity | Voltage (V vs. | Density | |
| LMFP:OLO:NMC | (mAh/g) | Gr) | (mWh/g) | Design Benefits |
| 10:45:45 | 236.5 | 3.9 | 922.4 | High capacity, high |
| | | | | voltage, high packing |
| | | | | density, good adhesion |
| 20:40:40 | 228 | 3.88 | 884.6 | Increased safety (vs. |
| | | | | NMC, OLO-rich) |
| 60:20:20 | 194 | 3.79 | 735.3 | Increased capacity (v. |
| | | | | LMFP-rich) |
| 80:10:10 | 177 | 3.74 | 662 | Improved thermal safety |
| | | | | and cost, reversibility |

*Specific capacity can change ±10%, and nominal voltage may vary ±0.1 V. Energy density is based on material-level by multiplying the specific capacity with nominal voltage, but is not calculated based on the cell level.

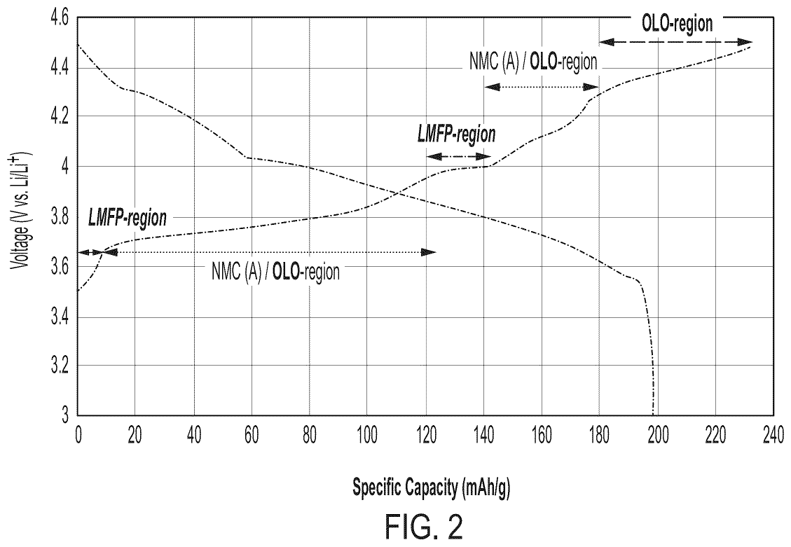

FIG. 2 shows a charge and discharge voltage versus capacity curve, according to some embodiments. First charging plateau from 3.4 to 3.6 V vs. Li/Li⁺ attribute to Fe²⁺/Fe³⁺ transition in the LMFP cathode material. Up to 3.9 to 4 V plateau, NMC(A) and OLO go through a redox transition such as Ni²⁺/Ni³⁺, Mn²⁺/Mn³⁺/Mn⁴⁺, and/or Co²⁺/Co³⁺. Then, 3.9 to 4 V vs. Li/Li⁺ region attributes to Mn²⁺/Mn³⁺ redox transition in LMFP. Up to 4.4 vs. Li/Li⁺ region, continued redox transition from NMC(A) and OLO occurs as lithium ions are being removed during the charging process from the host cathode materials. Li2MnO3-like region in OLO is being activated staring at 4.4 V vs. Li/Li⁺, where 02 gas is being released from the cathode surface. This is due to Mn⁴⁺ cannot further go to Mn⁵⁺, therefore O²⁻ is going through the anion redox process to become oxygen gas, when lithium extraction continues in the host cathode materials. This redox is irreversible, therefore a capacity loss is observed during the consecutive discharge cycle, losing about −30 mAh/g.

### Electrode Configurations

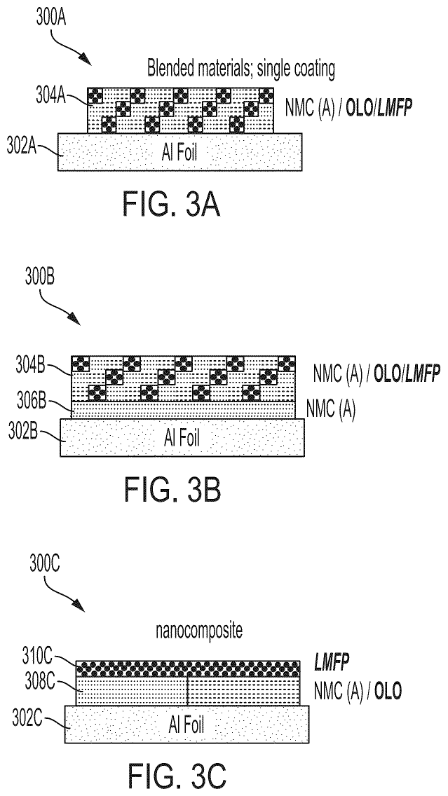

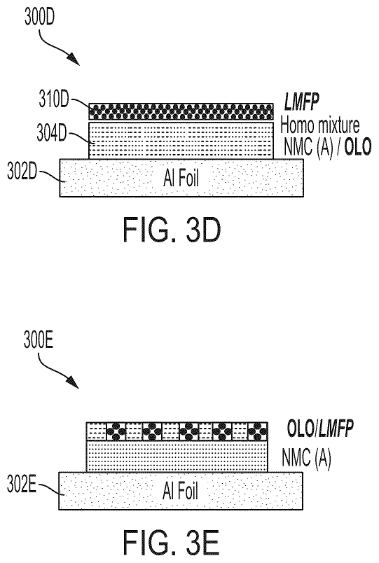

The three active materials described herein can be deposited onto a current collector in various configurations. For example, a single layer of a blend of the LMFP material, OLO material, and NMC material may be deposited directly onto the current collector. In some embodiments, the electrode may comprise one or more layers comprising a single active material. In some embodiments, an electrode may comprise both a layer comprising a single material and a layer comprising a blend of two or more materials. FIGS. 3A-3F show various electrode configurations that may be utilized in various applications. Each of the configurations depicted include an aluminum current collector. However, other types of current collectors may be used. One example is to utilize a carbon-coated aluminum collector that can help with electrode adhesion.

FIG. 3A shows an electrode configuration 300A comprising current collector 302A, and blended layer 304A, according to some embodiments. As shown, blended layer 304A is applied directly to current collector 302A. Blended layer 304A can include a blend of an LMFP material, an OLO material, and an NMC material as discussed herein. The embodiment of FIG. 3A only includes a single blended layer 304A deposited over current collector 302A. This type of electrode configuration occurs when NMC, OLO, and LMFP are blended during the electrode slurry preparation and coated directly on the Al foil. In some embodiments, the electrode configuration 300A includes no other deposited layers.

FIG. 3B shows an electrode configuration 300B comprising current collector 302B, first layer 306B, and blended layer 304B. As shown, the first layer 306B may comprise the NMC material. However, in some embodiments, first layer 304B may comprise OLO material. The first later 304B may also be deposited directly over the current collector 302B, and the blended layer 304B may be deposited on top of the first layer 306B. In some embodiments, the first layer 306B can improve adhesion of the electrode to the current collector, since LMFP materials generally have less adhesion to current collector 302B, and particularly to aluminum current collectors. This configuration is beneficial to improve the electrode adhesion between the interface of current collector 302B and first layer 306B and to add higher loading when to compared with configuration shown in FIG. 3A. The use of dual coating slot die is necessary to create two different slurries. The first slurry will only contain the NMC material, and the second slurry will contain a mixture of NMA, OLO, and LMFP.

FIG. 3C shows an electrode configuration 300C comprising current collector 302C, nanocomposite layer 308C, and LMFP material 310C. As shown, the nanocomposite layer 308C can include a nanocomposite of the NMC material and the OLO material. These two materials can be effectively combined to form a nanocomposite structure because they have similar crystal structures. The nanocomposite layer 308C may be deposited directly over the current collector 302C, and an LMFP material layer 310C may be deposited on top of the nanocomposite layer 308C. The total amount of each of the three materials may align with the blending ratios described herein. This type of configuration can help increase the energy density while exposing less amount of layered cathode materials (NMCA/OLO) to the surface. LMFP has the best thermal stability among three cathode systems, beneficial to be coated on the top of the electrode layer. In this case, we may use two different cathode materials to form a nanocomposite between NMCA and OLO.

FIG. 3D shows an electrode configuration 300D comprising current collector 302D, a blended layer 304D, and an LMFP material layer 310D. The blended layer 304D comprises a homogenous mixture of the NMC material and the OLO material and is deposited directly over the current collector 302D. These types of NMC/OLO homogenous mixture cathode may already exist within the cathode powders. The LMFP material layer 310D may be deposited on top of the nanocomposite layer 308D. The total amount of each of the three materials may align with the blending ratios described herein. This type of configuration can also help increase the energy density, while exposing less amount of layered cathode materials (NMCA/OLO) to the surface. LMFP has the best thermal stability among three cathode systems, beneficial to be coated on the top of the electrode layer.

FIG. 3E shows an electrode configuration 300E comprising current collector 302E, a first layer 306E, and a second layer 304E. First layer 306E can include a single active material, such as the NMC or OLO material. First layer 306E likely would not comprise the LMFP material, since LMFP shows poor adhesion to current collectors. The second layer 304E can include a binary mixture of two or more active materials. For example, second layer 304E can include a binary mixture of LMFP and OLO, or LMFP and NMC. The total amount of each of the three materials may align with the blending ratios described herein.

### Coatings

In some embodiments, one or more of the active materials described herein may comprise a coating. For example, the carbon coatings in LMFP can provide improved electronic conductivities. Specifically, M-P—O (metal phosphate) coatings may be help protection and lead to better stability for the cathode active material. Li-containing Li-M-P—O species can further increase ionic conductivity, if coated at the cathode surface. Increased rate capabilities can be helpful to improve the power performance of the electric vehicles, and provide for fast-charging characteristics.

Electrical conductivity is the movement of electrons (e⁻) when a current (I) is being applied. Adding a conductive agent such as carbon black, CNT, graphene at the electrode fabrication steps or introducing a thin layer of carbon coating on the active cathode material can help increase the electrical conductivity of a given battery system. In order to introduce a thin layer of carbon coating at the surface of active materials (e.g., only applicable to the LMFP material system described herein), a hydro-carbon (CₓH_{y}O_{z}) compound such as sucrose, glucose, citric acid, acetylene black, citric acid, oxalic acid, L-Ascorbic acid, etc. is blended, mixed, or milled together with a given active material (e.g., the LMFP material system described herein) or precursor. When these C-containing precursors are heated, the carbon source remains at the particle surface of the active materials, while H_{y}O_{z}, evaporates in the form of H₂O, OH, etc. In some embodiments, the gaseous species may include, but is not limited to CO, CO₂, O₂, NOₓ, SOₓ, Cl₂, H₂O, or a mixture of any two or more thereof.

M-P—O precursors may react with Li salts at the surface of the active materials forming a surface segregated Li-M₂-P—O material. In some embodiments, if the interfacial energy between the host cathode and Li-M₂-P—O is smaller, Li-M₂-P—O may be present in the form of precipitates within the host cathode matrix. When segregated toward the surface, the precursor and Li-M₂-P—O materials may have a reduced, or no, reaction tendency to form CO₂ gas when reacting with carbon. Therefore, it is expected that the modified active materials (e.g., only LMFP material system described herein) will provide a more uniform carbon coating quality and quantity in the given synthesis reaction condition.

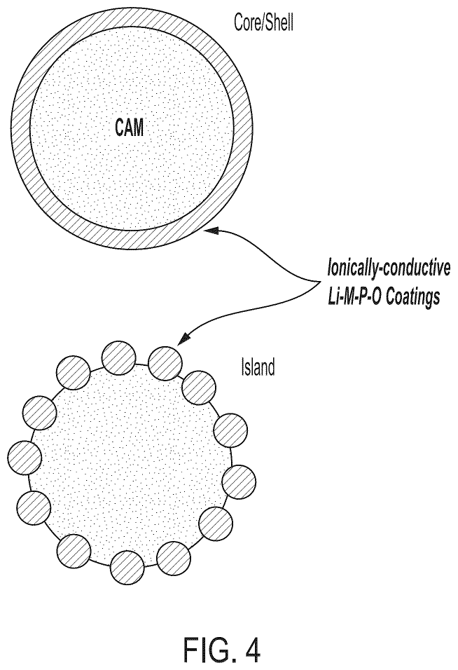

FIG. 4 shows an illustrative representation of coated active material particles, according to some embodiments. The top portion of the figure shows a core/shell type coating, and the bottom portion of the figure shows an island type coating. The Li-M-P—O coatings as described herein may form a layer (“shell”) on the surface of a cathode active material (CAM), “core” material. In some embodiment, coatings may form as discreet particles or “islands” on the surface of the CAM material that can any of a number of shapes including but not limited to the spheres, ellipsoid, or rods. In some embodiments, the CAM material is a commercially sourced and already has a first coating layer that may be discontinuous with gaps, where a new coating may fill in the discontinuous regions, or gaps.

The table below shows suitable materials for coating the active material particles, selected using the combination of materials simulation experiment and big data materials screening assisted by artificial intelligence.

| Li—M—P—O | [S/cm] | V vs. Li/Li⁺ | Classification |
|---|---|---|---|
| Li₃Mn₃(PO₄)₄ | 1.763 × 10⁻⁶ | 4.82 | High voltage, ionically conductive coating |
| LiGd(PO₃)₄ | 8.721 × 10⁻⁷ | N/A | Non-redox active, ionically conductive coating |
| LiCo(PO₃)₄ | 7.265 × 10⁻⁷ | 6.19 | High voltage, ionically conductive coating |
| Li₃Cr₂(PO₄)₃ | 6.167 × 10⁻⁷ | 4.44 | High voltage, ionically conductive coating |
| LiCo(PO₃)₃ | 5.335 × 10⁻⁷ | 5.25 | High voltage, ionically conductive coating |
| LiCoPO₄ | 3.636 × 10⁻⁷ | 4.80 | High voltage, ionically conductive coating |
| LiV(PO₃)₄ | 1.842 × 10⁻⁷ | 4.71 | High voltage, ionically conductive coating |
| LiZr₂(PO₄)₃ | 4.190 × 10⁻⁸ | N/A | Non-redox active, ionically conductive coating |
| LiCrP₂O₇ | 3.306 × 10⁻⁸ | 4.69 | High voltage, ionically conductive coating |
| LiInP₂O₇ | 1.186 × 10⁻⁸ | N/A | Non-redox active, ionically conductive coating |

Additional suitable coating materials can include that are ionically conductive are as follows:

| Secondary stable phase | log(conductivity) |
|---|---|
| Li₂VFe(P₂O₇)₂ | −4.7684 |
| Li₃V₂(PO₄)₃ | −5.4064 |
| LiV₂P₅O₁₆ | −5.4064 |
| Li₂InFe(P₂O₇)₂ | −5.7588 |
| Li₄MnV₃(P₂O₇)₄ | −5.8538 |
| LiVP₂O₇ | −5.8649 |
| Li₃Cr₂(PO₄)₃ | −6.2099 |
| LiV(PO₃)₄ | −6.7347 |
| LiMo₂(PO₄)₃ | −7.0317 |
| Li₈V₃P₈O₂₉ | −7.1956 |
| LiP₃(WO₆)₂ | −7.3334 |
| LiZr₂(PO₄)₃ | −7.3778 |
| Li₃Mo₃P₃O₁₇ | −7.4254 |
| LiCrP₂O₇ | −7.4807 |
| LiVPO₅ | −7.5251 |
| LiV₂(PO₄)₃ | −7.7741 |
| LiInP₂O₇ | −7.9260 |
| Li₁₁V₈(PO₄)₁₂ | −7.9853 |
| Li₂VCr(P₂O₇)₂ | −8.4025 |
| Li₉Cr₃P₈O₂₉ | −8.4445 |
| Li₃MnV(P₂O₇)₂ | −8.8431 |
| Li₆V₃P₈O₂₉ | −8.9148 |
| LiCr₄(PO₄)₃ | −9.3432 |
| Li₃Mo₂(PO₄)₃ | −9.4331 |
| LIMPO₄ (M = Fe, Mn) | −10.2819 |

### Battery Cells, Battery Modules, Battery Packs, and Electric Vehicle Systems

The LMFP/OLO/NMC system or blend described above can be used in the fabrication of electrodes. More specifically, the LMFP/OLO/NMC active material system described herein may be used in the fabrication of cathodes that can be used to form battery cells, battery modules, and/or battery packs. Battery cells, battery modules, and/or battery packs comprising cathodes fabricated using the blended active materials described herein may then be used as a power source in electric vehicles. These embodiments are described in detail below.

Reference will now be made to implementations and embodiments of various aspects and variations of battery cells, battery modules, battery packs, and the methods of making such battery cells, battery modules, and battery packs. Although several exemplary variations of the battery cells, modules, packs, and methods of making them are described herein, other variations of the battery cells, modules, packs and methods may include aspects of the battery cells, modules, packs and methods described herein combined in any suitable manner having combinations of all or some of the aspects described. In addition, any part of or any of the electrodes, densified electrodes, components, systems, methods, apparatuses, devices, compositions, etc. described herein can be implemented into the battery cells, battery modules, battery packs, and methods of making these battery cells, battery modules, and battery packs.

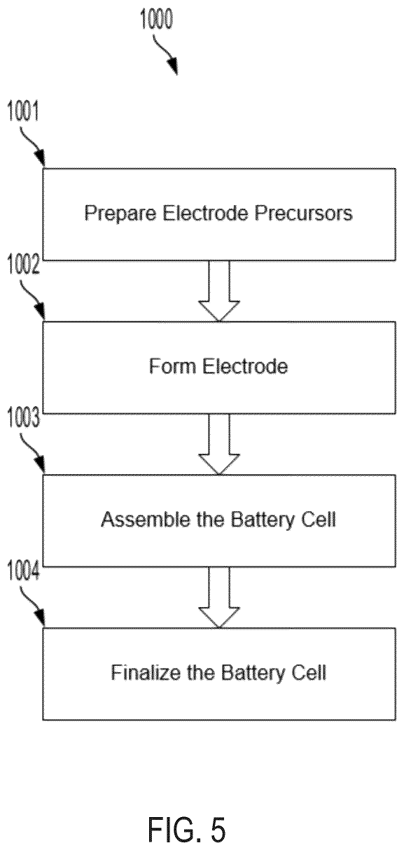

FIG. 5 illustrates a flow chart for a typical battery cell manufacturing process 1000. These steps are not exhaustive and other battery cell manufacturing processes can include additional steps or only a subset of these steps. At step 1001, the electrode precursors (e.g., binder, active material, conductive carbon additive) can be prepared. In some embodiments, this step can include mixing electrode materials (for example, active materials, and more specifically, the LMFP/OLO/NMC active material system described herein) with additional components (e.g., binders, solvents, conductive additives, etc.) to form an electrode slurry. In some embodiment, this step can include synthesizing the electrode materials themselves.

At step 1002, the electrode can be formed. In some embodiments, this step can include coating an electrode slurry on a current collector. In some embodiments, the electrode or electrode layer can include electrode active materials, conductive carbon material, binders, and/or other additives. In some embodiments, the electrode active materials can include cathode active materials, such as the LMFP/OLO/NMC active material system described herein.

In some embodiments, the electrode active materials can include anode active materials. In some embodiments, the anode active materials can include graphitic carbon (e.g., ordered or disordered carbon with sp² hybridization, artificial or natural Graphite, or blended), Li metal anode, silicon-based anode (e.g., silicon-based carbon composite anode, silicon metal, oxide, carbide, pre-lithiated), silicon-based carbon composite anode, lithium alloys (e.g., Li—Mg, Li—Al, Li—Ag alloy), lithium titanate, or combinations thereof. In some embodiments, an anode material can be formed within a current collector material. For example, an electrode can include a current collector (e.g., a copper foil) with an in situ-formed anode (e.g., Li metal) on a surface of the current collector facing the separator or solid-state electrolyte. In such examples, the assembled cell may not comprise an anode active material in an uncharged state.

In some embodiments, the conductive carbon material can include graphite, carbon black, carbon nanotubes, Super P carbon black material, Ketjen Black, Acetylene Black, SWCNT, MWCNT, carbon nanofiber, graphene, and combinations thereof. In some embodiments, the binders can include polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”), carboxymethylcellulose (“CMC”), agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrylic acid (PAA), poly(methyl acrylate) (PMA), poly(vinyl alcohol) (PVA), poly(vinyl acetate) (PVAc), polyacrylonitrile (PAN), polyisoprene (PIpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or combinations thereof.

After coating, the coated current collector can be dried to evaporate any solvent. In some embodiments, this step can include calendaring the coated current collectors. Calendaring can adjust the physical properties (e.g., bonding, conductivity, density, porosity, etc.) of the electrodes. In some embodiments, the electrode can then be sized via a slitting and/or notching machine to cut the electrode into the proper size and/or shape.

In some embodiments, solid electrolyte materials of the solid electrolyte layer can include inorganic solid electrolyte materials such as oxides, sulfides, phosphides, halides, ceramics, solid polymer electrolyte materials, hybrid solid state electrolytes, or glassy electrolyte materials, among others, or in any combinations thereof. In some embodiments, the solid electrolyte layer can include a polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B=Al, Ti), garnet-type with formula A₃B₂(XO₄)₃ (A=Ca, Sr, Ba and X=Nb, Ta), lithium phosphorous oxy-nitride (LiₓPO_{y}N_{z}), among others, or in any combinations thereof. In some embodiments, the solid electrolyte layer can include a glassy, ceramic and/or crystalline electrolyte material such as Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, lithium phosphorous oxy-nitride (LiₓPO_{y}N_{z}), lithium germanium phosphate sulfur (Li₁₀GeP₂S₁₂), Yttria-stabilized Zirconia (YSZ), NASICON (Na₃Zr₂Si₂PO₁₂), beta-alumina solid electrolyte (BASE), perovskite ceramics (e.g., strontium titanate (SrTiO₃)), Lithium lanthanum zirconium oxide (La₃Li₇O₁₂Zr₂), LiSiCON (Li₂₊₂ₓZn₁₋ₓGeO₄), lithium lanthanum titanate (Li₃ₓLa_{2/3-x}TiO₃) and/or sulfide-based lithium argyrodites with formula Li₆PS₅X (X=Cl, Br) like Li₆PS₅Cl, among others, or in any combinations thereof. Furthermore, solid state polymer electrolyte materials can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), and PEG, among others, or in any combinations thereof.

At step 1003, the battery cell can be assembled. After the electrodes, separators, and/or electrolytes have been prepared, a battery cell can be assembled/prepared. In this step, the separator and/or an electrolyte layer can be assembled between the anode and cathode layers to form the internal structure of a battery cell. These layers can be assembled by a winding method such as a round winding or prismatic/flat winding, a stacking method, or a z-folding method.

The assembled cell structure can then be inserted into a cell housing which is then partially or completed sealed. In addition, the assembled structure can be connected to terminals and/or cell tabs (via a welding process). For battery cells utilizing a liquid electrolyte, the housed cell with the electrode structure inside it can also be filled with electrolyte and subsequently sealed.

Battery cells can have a variety of form factors, shapes, or sizes. For example, battery cells (and their housings/casings) can have a cylindrical, rectangular, square, cubic, flat, or prismatic form factor, among others. There are four main types of battery cells: (1) button or coin cells; (2) cylindrical cells; (3) prismatic cells; and (4) pouch cells. Battery cells can be assembled, for example, by inserting a winding and/or stacked electrode roll (e.g., a jellyroll) into a battery cell casing or housing. In some embodiments, the winded or stacked electrode roll can include the electrolyte material. In some embodiments, the electrolyte material can be inserted in the battery casing or housing separate from the electrode roll. In some embodiments, the electrolyte material includes, but is not limited to, an ionically conductive fluid or other material (e.g., a layer) that can allow the flow of electrical charge (i.e., ion transportation) between the cathode and anode. In some embodiments, the electrolyte material can include a non-aqueous polar solvent (e.g., a carbonate such as ethylene carbonate, propylene carbonate, diethyl carbonate, ethyl methyl carbonate, dimethyl carbonate, or a mixture of any two or more thereof). The electrolytes may also include other additives such as, but not limited to, vinylidene carbonate, fluoroethylene carbonate, ethyl propionate, methyl propionate, methyl acetate, ethyl acetate, or a mixture of any two or more thereof. The lithium salt of the electrolyte may be any of those used in lithium battery construction including, but not limited to, lithium perchlorate, lithium hexafluorophosphate, lithium bis(fluorosulfonyl)imide, lithium bis(trifluorosulfonyl)imide, or a mixture of any two or more thereof. In addition, the salt may be present in the electrolyte from greater than 0 M to about 2 M.

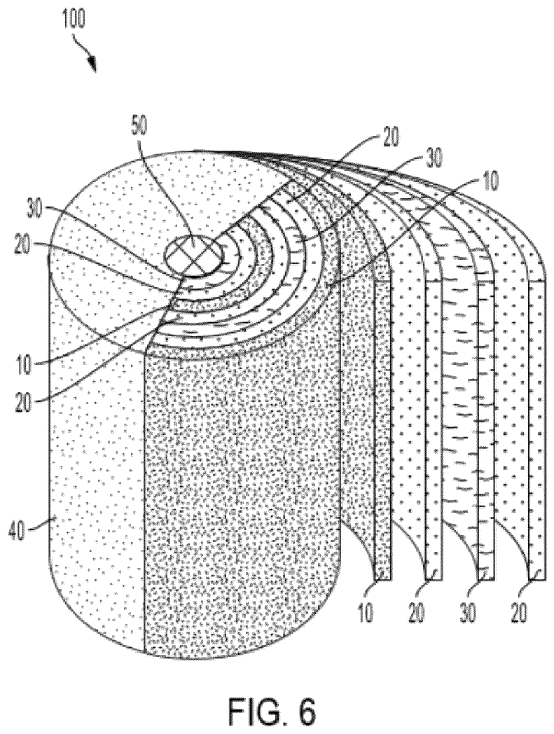

FIG. 6 depicts an illustrative example of a cross sectional view of a cylindrical battery cell 100. The cylindrical battery cell can include layers (e.g., sheet-like layers) of anode layers 10, separator and/or electrolyte layers 20, and cathode layers 30.

A battery cell can include at least one anode layer, which can be disposed within the cavity of the housing/casing. The battery cell can also include at least one cathode layer. The at least one cathode layer can also be disposed within the housing/casing. In some embodiments, when the battery cell is discharging (i.e., providing electric current), the at least one anode layer releases ions (e.g., lithium ions) to the at least one cathode layer generating a flow of electrons from one side to the other. Conversely, in some embodiments, when the battery cell is charging, the at least one cathode layer can release ions and the at least one anode layer can receive these ions.

These layers (cathode, anode, separator/electrolyte layers) can be sandwiched, rolled up, and/or packed into a cavity of a cylinder-shaped casing 40 (e.g., a metal can). The casings/housings can be rigid such as those made from metallic or hard-plastic, for example. In some embodiments, a separator layer (and/or electrolyte layer) 20 can be arranged between an anode layer 10 and a cathode layer 30 to separate the anode layer 20 and the cathode layer 30. In some embodiments, the layers in the battery cell can alternate such that a separator layer (and/or electrolyte layer) separates an anode layer from a cathode layer. In other words, the layers of the battery electrode can be (in order) separator layer, anode/cathode layer, separator layer, opposite of other anode/cathode layer and so on. The separator layer (and/or electrolyte layer) 20 can prevent contact between the anode and cathode layers while facilitating ion (e.g., lithium ions) transport in the cell. The battery cell can also include at least one terminal 50. The at least one terminal can be electrical contacts used to connect a load or charger to a battery cell. For example, the terminal can be made of an electrically conductive material to carry electrical current from the battery cell to an electrical load, such as a component or system of an electric vehicle as discussed further herein.

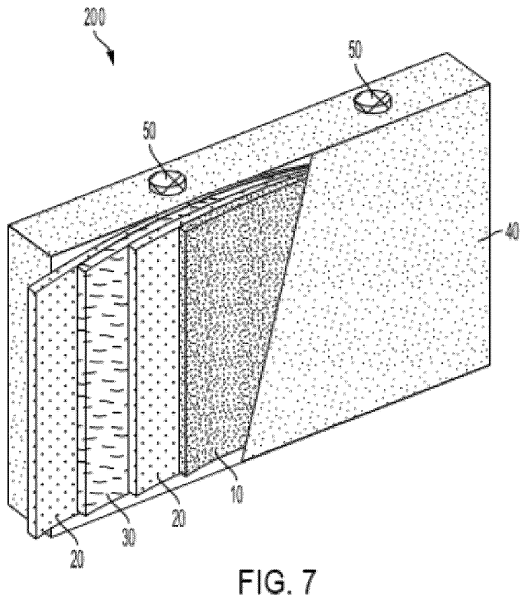

FIG. 7 depicts an illustrative example of a cross sectional view of a prismatic battery cell 200. The prismatic battery cell can include layers (e.g., sheet-like layers) of anode layers 10, separator and/or electrolyte layers 20, and cathode layers 30. Similar to the cylindrical battery cell, the layers of a prismatic battery cell can be sandwiched, rolled, and/or pressed to fit into cubic or rectangular cuboid (e.g., hyperrectangle) shaped casing/housing 40. In some embodiments, the layers can be assembled by layer stacking rather than jelly rolling. In some embodiments, the casing or housing can be rigid such as those made from a metal and/or hard-plastic. In some embodiments, the prismatic battery cell 200 can include more than one terminal 50. In some embodiments, one of these terminals can be the positive terminal and the other a negative terminal. These terminals can be used to connect a load or charger to the battery cell.

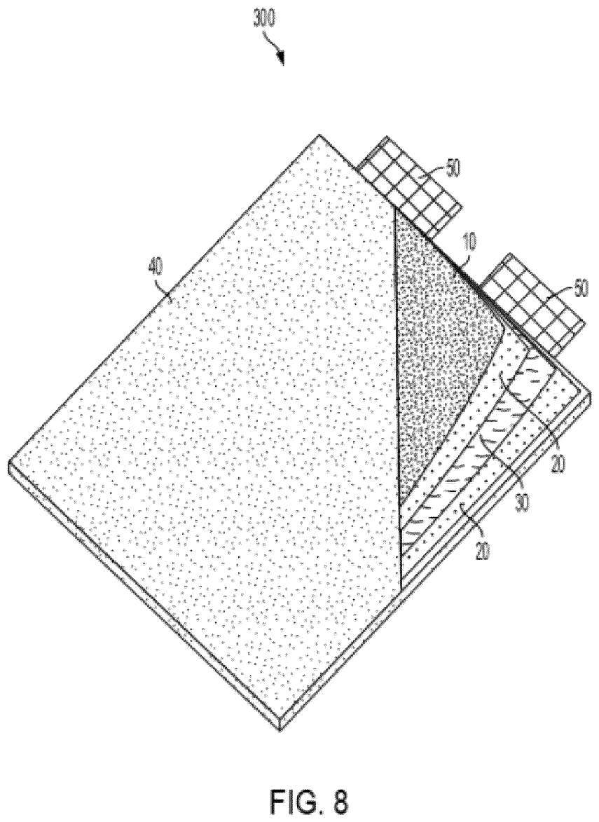

FIG. 8 depicts an illustrative example of a cross section view of a pouch battery cell 300. The pouch battery cells do not have a rigid enclosure and instead use a flexible material for the casing/housing 40. This flexible material can be, for example, a sealed flexible foil. The pouch battery cell can include layers (e.g., sheet-like layers) of anode layers 10, separator and/or electrolyte layers 20, and cathode layers 30. In some embodiments, these layers are stacked in the casing/housing. In some embodiments, the pouch battery cell 200 can include more than one terminal 50. In some embodiments, one of these terminals can be the positive terminal and the other the negative terminal. These terminals can be used to connect a load or charger to the battery cell.

The casings/housings of battery cells can include one or more materials with various electrical conductivity or thermal conductivity, or a combination thereof. In some embodiments, the electrically conductive and thermally conductive material for the casing/housing of the battery cell can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. In some embodiments, the electrically conductive and thermally conductive material for the housing of the battery cell can include a ceramic material (e.g., silicon nitride, silicon carbide, titanium carbide, zirconium dioxide, beryllium oxide, and among others) and/or a thermoplastic material (e.g., polyethylene, polypropylene, polystyrene, polyvinyl chloride, or nylon), among others.

At step 1004, the battery cell can be finalized. In some embodiments, this step includes the formation process wherein the first charging and discharging process for the battery cell takes place. In some embodiments, this initial charge and discharge can form a solid electrolyte interface between the electrolyte and the electrodes. In some embodiments, this step may cause some of the cells to produce gas which can be removed in a degassing process from the battery cell. In some embodiments, this step includes aging the battery cell. Aging can include monitoring cell characteristics and performance over a fixed period of time. In some embodiments, this step can also include testing the cells in an end-of-line (EOL) test rig. The EOL testing can include discharging the battery cells to the shipping state of charge, pulse testing, testing internal resistance measurements, testing OCV, testing for leakage, and/or optically inspecting the battery cells for deficiencies.

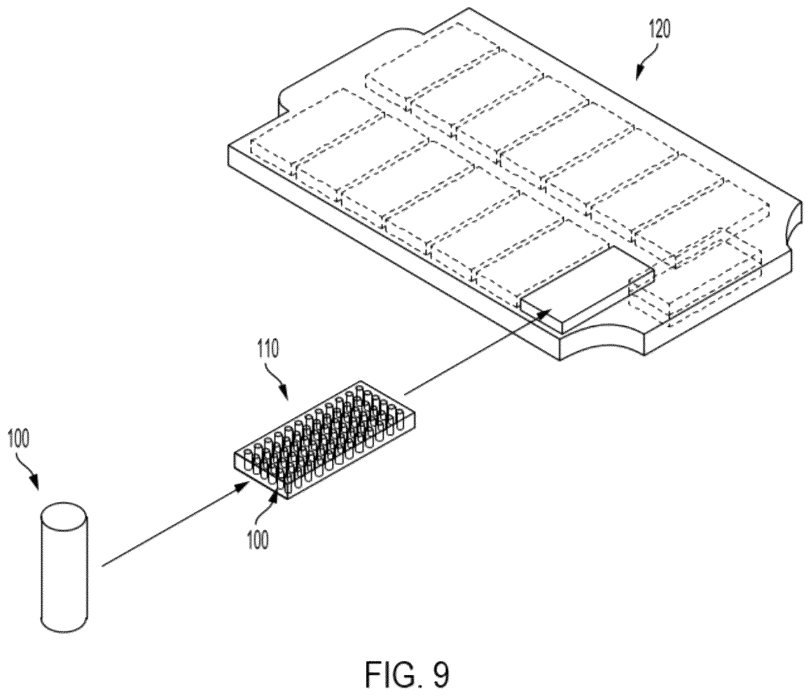

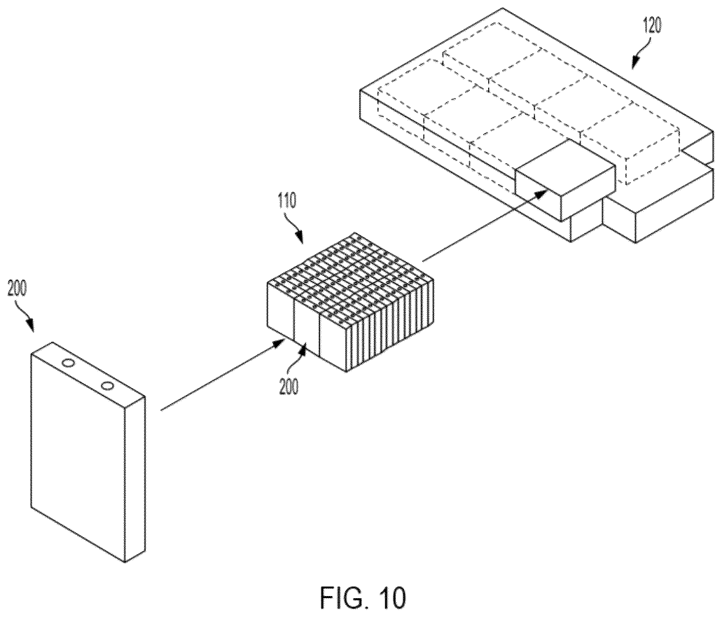

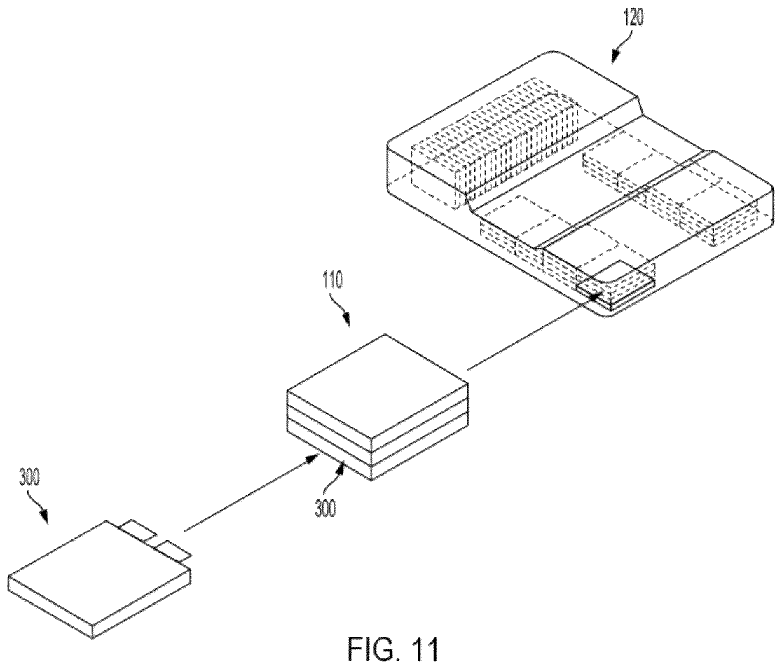

A plurality of battery cells (100, 200, and/or 300) can be assembled or packaged together in the same housing, frame, or casing to form a battery module and/or battery pack. The battery cells of a battery module can be electrically connected to generate an amount of electrical energy. These multiple battery cells can be linked to the outside of the housing, frame, or casing, through a uniform boundary. The battery cells of the battery module can be in parallel, in series, or in a series-parallel combination of battery cells. The housing, frame, or casing can protect the battery cells from a variety of dangers (e.g., external elements, heat, vibration, etc.). FIG. 9 illustrates cylindrical battery cells 100 being inserted into a frame to form battery module 110. FIG. 10 illustrates prismatic battery cells 200 being inserted into a frame to form battery module 110. FIG. 11 illustrates pouch battery cells 300 being inserted into a frame to form battery module 110. In some embodiments, the battery pack may not include modules. For example, the battery pack can have a “module-free” or cell-to-pack configuration wherein battery cells are arranged directly into a battery pack without assembly into a module.

A plurality of the battery modules 110 can be disposed within another housing, frame, or casing to form a battery pack 120 as shown in FIGS. 9-11. In some embodiments, a plurality of battery cells can be assembled, packed, or disposed within a housing, frame, or casing to form a battery pack (not shown). In such embodiments, the battery pack may not include a battery module (e.g., module-free). For example, the battery pack can have a module-free or cell-to-pack configuration where the battery cells can be arranged directly into a battery pack without assembly into a battery module. In some embodiments, the battery cells of the battery pack can be electrically connected to generate an amount of electrical energy to be provided to another system (e.g., an electric vehicle).

The battery modules of a battery pack can be electrically connected to generate an amount of electrical energy to be provided to another system (e.g., an electric vehicle). The battery pack can also include various control and/or protection systems such as a heat exchanger system (e.g., a cooling system) configured to regulate the temperature of the battery pack (and the individual modules and battery cells) and a battery management system configured to control the battery pack's voltage, for example. In some embodiments, a battery pack housing, frame, or casing can include a shield on the bottom or underneath the battery modules to protect the battery modules from external elements. In some embodiments, a battery pack can include at least one heat exchanger (e.g., a cooling line configured to distribute fluid through the battery pack or a cold plate as part of a thermal/temperature control or heat exchange).

In some embodiments, battery modules can collect current or electrical power from the individual battery cells that make up the battery modules and can provide the current or electrical power as output from the battery pack. The battery modules can include any number of battery cells and the battery pack can include any number of battery modules. For example, the battery pack can have one, two, three, four, five, six, seven, eight, nine, ten, eleven, twelve or other number of battery modules disposed in the housing/frame/casing. In some embodiments, a battery module can include multiple submodules. In some embodiments, these submodules may be separated by a heat exchanger configured to regulate or control the temperature of the individual battery module. For example, a battery module can include a top battery submodule and a bottom battery submodule. These submodules can be separated by a heat exchanger such as a cold plate in between the top and bottom battery submodules.

The battery packs can come in all shapes and sizes. For example, FIGS. 9-11 illustrates three differently shaped battery packs 120. As shown in FIGS. 9-11, the battery packs 120 can include or define a plurality of areas, slots, holders, containers, etc. for positioning of the battery modules. The battery modules can come in all shapes and sizes. For example, the battery modules can be square, rectangular, circular, triangular, symmetrical, or asymmetrical. In some examples, battery modules in a single battery pack may be shaped differently. Similarly, the battery module can include or define a plurality of areas, slots, holders, containers, etc. for the plurality of battery cells.

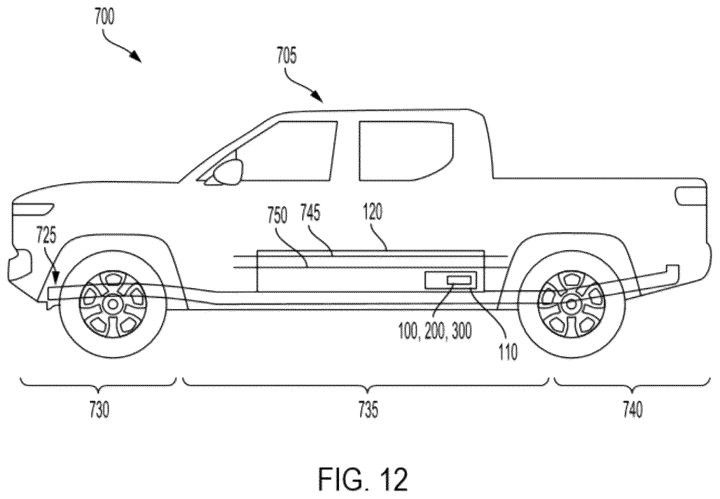

FIG. 12 illustrates an example of a cross sectional view 700 of an electric vehicle 705 that includes at least one battery pack 120. Electric vehicles can include, but are not limited to, electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. Electric vehicles can be fully electric or partially electric (e.g., plug-in hybrid) and further, electric vehicles can be fully autonomous, partially autonomous, or unmanned. In addition, electric vehicles can also be human operated or non-autonomous.

Electric vehicles 705 can be installed with a battery pack 120 that includes battery modules 112 with battery cells (100, 200, and/or 300) to power the electric vehicles. The electric vehicle 705 can include a chassis 725 (e.g., a frame, internal frame, or support structure). The chassis 725 can support various components of the electric vehicle 705. In some embodiments, the chassis 725 can span a front portion 730 (e.g., a hood or bonnet portion), a body portion 735, and a rear portion 740 (e.g., a trunk, payload, or boot portion) of the electric vehicle 705. The battery pack 120 can be installed or placed within the electric vehicle 705. For example, the battery pack 120 can be installed on the chassis 725 of the electric vehicle 705 within one or more of the front portion 730, the body portion 735, or the rear portion 740. In some embodiments, the battery pack 120 can include or connect with at least one busbar, e.g., a current collector element. For example, the first busbar 745 and the second busbar 750 can include electrically conductive material to connect or otherwise electrically couple the battery pack 120 (and/or battery modules 112 or the battery cells 100, 200, and/or 300) with other electrical components of the electric vehicle 705 to provide electrical power to various systems or components of the electric vehicle 705. In some embodiments, battery pack 120 can also be used as an energy storage system to power a building, such as a residential home or commercial building instead of or in addition to an electric vehicle.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1: An electrode for a lithium-ion battery comprising:
a lithium metal phosphate material;
a lithiated-oxide material comprising Li_{1+y}M_{1-y}O₂, where 0≤y≤0.4 and M is a transition metal and more than one molar equivalent of lithium relative to an amount of transition metal; and
a lithium nickel manganese cobalt oxide material.

2: The electrode of claim 1, wherein the lithium metal phosphate material comprises LiMnₓFe₁₋ₓPO₄, where 0.5≤x≤0.9.

3. (canceled)

4: The electrode of claim 1, wherein the nickel manganese cobalt oxide material comprises at least 80 wt. % of nickel.

5: The electrode of claim 1, wherein one or more of: the lithium metal phosphate material has a D50 particle size of 0.7-11.0 μm, the lithiated-oxide material has a D50 particle size of 3-14 μm, or the nickel manganese cobalt oxide material has a D50 particle size of 3-15 μm.

6-7. (canceled)

8: The electrode of claim 1, wherein one or more of: the lithium metal phosphate material has a specific surface area of 10-35 m²/g, the lithiated-oxide material has a specific surface area of 1-6 m²/g, or the nickel manganese cobalt oxide material has a specific surface area of 0.2-1 m²/g.

9: The electrode of claim 1, wherein the lithium metal phosphate material has a carbon content of 1.0-3.5 wt. %.

10: The electrode of claim 1, comprising greater than or equal to 60 wt. % of lithium metal phosphate material.

11: The electrode of claim 1, comprising less than or equal to 40 wt. % of lithiated-oxide material and nickel manganese cobalt oxide material combined.

12: The electrode of claim 1, comprising a single deposited layer of a blend of the lithium metal phosphate material, the lithiated-oxide material, and the nickel manganese cobalt oxide material.

13: The electrode of claim 1, comprising a first deposited layer comprising only one of the nickel manganese cobalt oxide material or the lithiated-oxide material.

14: The electrode of claim 13, comprising a second deposited layer overlying the first deposited layer comprising a blended mixture of two or more of the lithium metal phosphate material, the lithiated-oxide material, and the nickel manganese cobalt oxide material.

15: The electrode of claim 1, comprising a first deposited layer comprising only the nickel manganese cobalt oxide material and the lithiated-oxide material.

16: The electrode of claim 15, wherein the first deposited layer comprises a nanocomposite of the nickel manganese cobalt oxide material and the lithiated-oxide material, and the electrode comprises a second deposited layer comprising only the lithium metal phosphate material overlying the first deposited layer.

17: The electrode of claim 15, wherein the first deposited layer comprises a homogenous mixture of the nickel manganese cobalt oxide material and the lithiated-oxide material, and the electrode comprises a second deposited layer comprising only the lithium metal phosphate material overlying the first deposited layer.

18: A rechargeable lithium-ion battery comprising:
an electrode comprising:
a lithium metal phosphate material;
a lithiated-oxide material comprising Li_{1+y}M_{1-y}O₂, where 0<y≤0.4 and M is a transition metal and more than one molar equivalent of lithium relative to an amount of transition metal; and
a lithium nickel manganese cobalt oxide material.

19: The battery of claim 18, having a specific capacity of 175-240 mAh/g and a nominal voltage of 3.7-4.0 V vs. graphite.

20: An electric vehicle system comprising the rechargeable lithium-ion battery of claim 18.

21-22. (canceled)
